(19) United States
(12) Patent Application Publication
(10) Pub. No.: US 2014/0267728 A1
(43) Pub. Date: Sep. 18, 2014

(54) VEHICLE DETECTION AND IMAGE CAPTURE SYSTEM AND METHODS FOR DETECTING AND CAPTURING IMAGES OF VEHICLES

(71) Applicant: 3M INNOVATIVE PROPERTIES COMPANY, St. Paul, MN (US)

(72) Inventor: Thomas J. Dahlin, St. Louis Park, MN (US)

(73) Assignee: 3M INNOVATIVE PROPERTIES COMPANY, St. Paul, MN (US)

(21) Appl. No.: 13/829,195

(22) Filed: Mar. 14, 2013

(51) Int. Cl. H04N 7/18; G06K 7/10

(52) U.S. Cl. CPC H04N 7/188; G06K 7/10366
USPC 348/148

(57) ABSTRACT

A vehicle detection and image capture system that detects a vehicle at the location of a radio frequency identification tag when a radio frequency identification reader fails to receive a response from the radio frequency identification tag during interrogation, and captures an image of the vehicle with a camera.

### BACKGROUND

As a way to increase government funding for new roads and road maintenance, local and federal governments have installed toll roads and the use of electronic tolling as an effective way to increase revenue. Electronic tolling systems typically include the use of radio frequency identification (“RFID”) tags or transponders located in vehicles, such as on windows or attached to dashboards, and RFID readers located above the roads, where the RFID readers interrogate the RFID tags, as the vehicles travel under the RFID readers. Electronic tolling systems determine whether the vehicles passing are enrolled in the program, alerts enforcers for those that are not, and electronically debits the accounts of registered car owners without requiring them to stop.

Some examples of prior art electronic tolling systems include: U.S. Pat. No. 3,602,881, “Automatic Toll Charging System,” (Bayne et al.), U.S. Pat. No. 4,338,587, “Toll Collection System,” (Chiappetti), U.S. Pat. No. 5,144,553, “Electronic Vehicle Toll Collection System and Method,” (Hassett et al.), U.S. Pat. No. 5,406,275, “Object Location Process and Apparatus,” PCT Published Patent Application No. WO 95/17740, “Automatic Vehicle Identification Toll Collection System with Optical Vehicle Recognition.”

RFID technology has been used in other applications, such as for parking applications, as disclosed in U.S. Patent Publication 2012/0086558 A1, “Lane Position Detection Arrangement Using Radio Frequency Identification,” (Teske).

### SUMMARY

One aspect of the present invention provides a vehicle detection and image capture system. In this aspect, the vehicle detection and image capture system comprises: a first radio frequency identification tag fixed at a location relative to a road; a first radio frequency identification reader positioned to interrogate the first radio frequency identification tag; and a first camera; wherein a vehicle is detected at the location of the first radio frequency identification tag when the first radio frequency identification reader fails to receive a response from the first radio frequency identification tag during interrogation, and the camera captures an image of the vehicle.

Another aspect of the present invention provides an alternative detection and image capture system. In this aspect, the vehicle detection and image capture system comprises: a first and a second radio frequency identification tag fixed at different locations relative to a road; and a first radio frequency identification reader positioned to interrogate the first radio frequency identification tag; a camera; wherein a vehicle is detected at the location of the first radio frequency identification tag when the first radio frequency identification reader fails to receive a response from the first radio frequency identification tag during interrogation, wherein the vehicle is detected at the location of the second radio frequency identification tag when the first radio frequency identification reader fails to receive a response from the second radio frequency identification tag during interrogation, and wherein the speed of the vehicle is calculated for travel between the first and second radio frequency identification tags; and wherein the camera captures an image of the vehicle.

Yet another aspect of the invention provides a method of detecting and capturing an image of a vehicle. In this aspect, the method comprises: providing a first radio frequency identification tag fixed at a location relative to a road; providing a first radio frequency identification reader positioned to interrogate the first radio frequency identification tag; and providing a first camera; detecting a vehicle at the location of the first radio frequency identification tag when the first radio frequency identification reader fails to receive a response from the first radio frequency identification tag during interrogation; and capturing an image of the vehicle with the camera.

The above summary of the present invention is not intended to describe each disclosed embodiment or every implementation of the present invention. The Figures and the detail description, which follow, more particularly exemplify illustrative embodiments.

### BRIEF DESCRIPTION OF THE DRAWINGS

The present invention will be further explained with reference to the appended Figures, wherein like structure is referred to by like numerals throughout the several views, and wherein:

FIG. 1 is a top view of an exemplary embodiment of the vehicle detection and image capture system of the present invention;

FIG. 2a is a side view of the system of FIG. 1;

FIG. 2b is a side view of the system of FIG. 2a where the vehicle blocks the communication between a RFID tag and a RFID reader;

FIG. 3 is an exploded, cross-sectional view of an exemplary embodiment of RFID tags embedded in pavement marking tape;

FIG. 4 is a partially exploded view of an exemplary embodiment of a raised pavement marker including an RFID tag;

FIG. 5 is isometric view of another exemplary raised pavement marker including an RFID tag; and

FIG. 6 is a top view of another exemplary embodiment of the vehicle detection and image capture system of the present invention.

### DETAILED DESCRIPTION

As mentioned in the Background, as a way to increase government funding for new roads and road maintenance, local and federal governments have installed toll roads and the use of electronic tolling as an effective way to increase revenue. There is a need to expand electronic tolling technology to the use of non-toll roads, yet making sure that the barriers for installing such technology are sufficiently low enough to allow government entities to make the investment

Some electronic tolling systems may require the use of inductive loops sensors. Inductive loop sensors are often embedded in pavement to detect a vehicle's presence, when the vehicle is located roughly overhead the sensors. During operation, a loop sensor generates an oscillating inductive field. When a vehicle (or other metal object) passes over an inductive loop sensor, the frequency of the inductive field changes. When the inductive field change is sufficiently large, it is assumed that the change is due to a vehicle passing overhead, and the vehicle is registered. For example, traffic light intersections and garage entrances may incorporate such inductive loop sensors.

Loop sensors can be sensitive to environmental changes, such as extreme temperature changes or lightning conditions. Loop sensors can also suffer from cross-coupled frequencies between multiple sensors in a lane, or from adjoining lanes. Additionally, loop sensors can provide different results for vehicles with different ground clearances, and for vehicles of various sizes and materials. Additionally, the presence of rebar or other metals, such as conduit, underneath a loop can also affect loop readings.

The vehicle detection and image capture system of the present invention convenient works in conjunction with electronic tolling systems without the need to install new inductive loop sensors in existing roads. The system of the present invention allows an existing road to be retrofitted and made into a toll road without the need for extra expense of electronics or maintenance of embedded inductive loop sensors. The system of the present invention uses RFID tags and readers to signal the presence of a moving vehicle and to trigger a camera to capture an image of the moving vehicle. The image of the vehicle then may be used as documentation leading to enforcement of the toll road, either in terms of determining whether the vehicles passing are enrolled in the program, alerts enforcers for those that are not, and for vehicles that are traveling above the designated speed limit. FIGS. 1, 2a-b, and 6 illustrate different embodiments of the vehicle detection and image capture system of the present invention, which is useful for such enforcement purposes.

In FIGS. 1 and 2a-b, system 10 includes a radio frequency identification (“RFID”) tag 16 at a fixed location relative to a road 12. The system may include any number of RFID tags. In the illustrated embodiment, the system 10 includes a plurality of RFID tags 16a, 16b, 16c, and 16d. First RFID tag 16a is at a fixed location in a first vehicle lane, while second RFID tag 16b is at a fixed location in an adjacent second vehicle lane. Third RFID tag 16c is at a fixed location in the first vehicle lane, while the fourth RFID tag 16d is at a fixed location in the adjacent second vehicle lane. Examples of suitable RFID tags useful in system 10 include passive and active ultra high frequency (“UHF”) RFID tags commercially available from Sirit, Inc. which is now part of 3M Company based in St. Paul, Minn. Alternatively, suitable RFID tags useful in the system include passive and active UHF RFID tags commercially available from Impinj, Inc. based in Seattle, Wash., and commercially available from Transcore, Inc. based in Harrisburg, Pa.

The RFID tags 16 may be fixed to locations relative to the road 12 in any way known to those skilled in the art. FIG. 1 illustrates one exemplary embodiment, where the RFID tags 16 are part of pavement marking tape 30 that is adhered to road 12. FIG. 1 illustrates the pavement marking tape 30 as a longitudinally extending tape 30 positioned perpendicular to the direction of travel of the vehicles. One embodiment of pavement marking tape 30 is discussed and illustrated in more detail in FIG. 3. Alternatively, RFID tags 16 may be fixed at locations through use of raised pavement markers 50. Two embodiments of raised pavement markers 50a, 50b are discussed and illustrated in more detail in FIGS. 4 and 5, respectively. As yet another alternative, the RFID tags 16 may be attached to road by forming pockets into the existing road surfaces, placing the RFID tags 16 into such pockets, and then providing a protective cover over the pocket, while still allowing the RFID tags to be interrogated successfully.

The vehicle detection and image capture system of the present invention also includes a RFID reader 22. The RFID reader 22 is positioned to interrogate the RFID tag. In the illustrated embodiment of FIGS. 1 and 2, the RFID reader 22 is fixed to a gantry pole locate above the road 12 where the vehicles 14 are traveling. The RFID reader 22 is positioned such that it may interrogate its corresponding RFID tag(s) 16. For example, a first RFID reader 22a is positioned to interrogate a first RFID tag 16a. A second RFID reader 22b is positioned to interrogate a second RFID tag 16b. The RFID readers 22 may also optionally read additional tags positioned within the read range of the RFID reader 22. For example, the first RFID reader 22a is positioned to interrogate the third RFID tag 16c, and the second RFID reader 22b is positioned to interrogate the fourth RFID tag 16d. Examples of suitable commercially available RFID readers useful in the system include Sirit™ Infinity™ 510 RFID readers and Impinj™ Speedway™ R420 RFID readers.

The vehicle detection and image capture system of the present invention also includes a camera 18. The camera 18 is positioned to capture an image of the vehicle 14. In the illustrated embodiment, the camera 18 is attached to the gantry pole 20. As explained in more detail below, the RFID reader 22 and camera work in conjunction to capture an image of the vehicle 14, when the vehicle 14 blocks the signal between the RFID reader 22 and the RFID tag 16. The camera 22 may be positioned to take any particular image of the vehicle 14. For example, the camera could be positioned to capture an image of the vehicle's license plate, a portion of the vehicle, and/or an image of the whole vehicle 14. In the illustrated embodiments of FIGS. 1 and 2a-b, the system 10 includes a first camera 18a affiliated with the first RFID reader 22a and a second camera 18b affiliated with the second RFID reader 18b. Examples of suitable commercially available cameras useful in the system 10 include PIPS cameras from PIPS Technology, which is now part of 3M Company based in St. Paul, Minn. Other suitable commercially available cameras are available from Elsag North America based in Brewster, N.Y. or from Perceptics Imaging Technology Solutions, based in Knoxville, Tenn.

The vehicle 14 may include another RFID tag 24 located in the vehicle. One example of a suitable commercially available RFID tag 24 for use in the vehicle includes passive and active UHF RFID tags commercially available from Sirit, Inc., which is now part of 3M Company based in St. Paul, Minn. Alternatively, suitable RFID tags 24 useful in the system include passive and active UHF RFID tags commercially available from Impinj, Inc. based in Seattle, Wash., and manufactured by Transcore, Inc. based in Harrisburg, Pa.

The RFID reader 22 may be designed to interrogate the RFID tag 24 for automatic vehicle identification and for tolling purposes. For example, the RFID reader 22 interrogates the RFID tag 24, as the vehicle drives into the interrogation or read range of the RFID reader 22. Alternatively, the system may include a separate RFID reader (not shown) which is used solely for the purposes of interrogating the RFID tag 24 in the vehicle 14. Federal Signal Technologies Corporation, which is now part of 3M Company based in St. Paul, Minn., provides commercially available RFID tags, readers and systems for use in toll based or vehicle identification RFID applications.

FIGS. 1 and 2a-b illustrate that the system 10 may include a first RFID tag 16a and a second RFID tag 24 located in the vehicle 14. The system 10 may include a first RFID reader 22a positioned to interrogate both the first RFID tag 16 and the second RFID tag 24. Alternatively, the system 10 may include a first RFID reader 22a to interrogate the first RFID tag 16a and a second RFID reader (not illustrated) positioned to interrogate the second RFID tag 24.

FIGS. 1 and 2a-b are convenient for illustrating the vehicle detection and image capture features of the system 10. The RFID reader 22 interrogates the RFID tag 16 and receives a signal back from the tag, as illustrated in FIG. 2a. In one embodiment, the RFID reader 22 is continuously interrogates the RFID tag 16. In another embodiment, the RFID reader 22 intermittedly interrogates the RFID tag 16. As shown in FIG. 2b, as the vehicle 14 drives over or is positioned over the RFID tag 16, the communication between the RFID tag 16 and the RFID reader 22 is blocked, and in essence, it is determined that the vehicle 14 is at the general location of the RFID tag 16, i.e. the vehicle 14 is detected at the general location of the RFID tag 16. When this happens, the camera 18 is triggered to capture an image of the vehicle. The image of the vehicle, whether it is a partial or full image of the vehicle or an image of just the license plate, is then recorded and used later for enforcement purposes. For example, if the toll based RFID system determines that the vehicle does not have an authorized RFID tag 24, the camera 18 provides an image of the vehicle to prove that unauthorized access to the toll road has occurred.

The system 10 of the present invention determines the presence of a vehicle 14 when the RFID reader 22 fails to receive a response from the first RFID tag 16 during interrogation. If the RFID signal between the RFID reader 22 and the RFID tag 16 is blocked, it is premised that a vehicle has driven over the area where the RFID tag 16 is located relative to the road 12.

In one embodiment of the system 10, the camera 18 could be fixed in the direction of a specific RFID tag 16 to capture the image of the vehicle traveling over that specific RFID tag. In an alternative embodiment of the system 10, where there is a plurality of RFID tags 16 fixed at different locations relative to a road 12, the camera 18 may be moveable in the direction of the RFID tag 16 that failed to respond during the interrogation from its corresponding RFID reader 22. In yet another alternative embodiment of the system 10, system 10 may include a plurality of RFID tags 16, a plurality of RFID readers 22 where each reader is interrogating a different RFID tag or a different group of RFID tags 16, and a plurality of cameras 18, where each camera is focused in the direction of a different RFID tag or group of RFID tags to capture the image of a vehicle 14 traveling over that specific RFID tag 16 or group of RFID tags 16. Alternatively, the system 10 could include a single RFID reader 22 having a first antenna positioned to interrogate the first RFID tag 16a and a second antenna positioned to interrogate the second RFID tag 16b.

The image captured by the camera 18 and later recorded may optionally be used to verify the event that a vehicle was present or located over the RFID tags 16 or group of tags 16 at a particular point in time. In addition, the event that a vehicle was present or located over the RFID tags or group of tags at a particular point in time may be optionally verified by the interrogation of the RFID tag 24 in the vehicle 10 by the RFID reader 22. In fact, the identity of the vehicle's owner may be identified when the RFID tag 24 is interrogated by the RFID reader 22.

Alternatively, the image captured by the camera 18 may be processed for automated vehicle identification by an Automated License Plate Recognition Camera, Model 382, which commercially available from PIPS Technology, which is now part of 3M Company, based in St. Paul, Minn.

FIG. 3 illustrates an exploded, cross-sectional view of an exemplary embodiment of RFID tags 16 embedded in pavement marking tape 30. The pavement marking tape 30 includes several layers of materials. The first layer is a layer of glass beads 32. The glass beads 32 are adhered to a textured rubber base 36 by a layer of adhesive 34. Inside the textured rubber base 36 there is a recess for receiving an RFID tag 16. The RFID tag 16 is then held in place by a fiberglass netting 40 and a layer of adhesive 38. The fiberglass netting 40 also provides strength to the pavement marking tape. Lastly, there is a layer of adhesive 42 for adhering the pavement marking tape 30 to a road 12. Alternatively, the layer of glass beads 32 and layer of adhesive 34 may be substituted with Diamond Grade™ High Intensity Prismatic Sheeting, Series 3930, commercially available from 3M Company based in St. Paul. The pavement marking tape 30 may be assembled by methods known to those skilled in the art.

FIG. 4 is a partially exploded view of an exemplary embodiment of a raised pavement marker 50a including an RFID tag 16. The raised pavement marker 50a includes a top surface 56 and a bottom surface 58 opposite the top surface 56. The raised pavement marker also includes two opposing angled side surfaces 52, 54 adjacent the top surface 56 and bottom surface 58. The angled surfaces 52 and 54 are convenient for mounting an RFID tag 16. The angled side surfaces 52, 54 are designed to help optimize the readability of the RFID tag 16 by a RFID reader 22 mounted on the gantry pole 20.

Retroreflective sheeting 60 may overlay the RFID tag 16. In a preferred embodiment, the retroreflective sheeting is non-metalized (i.e. prismatic), retroreflective sheeting. One suitable non-metalized reflective sheeting is commercially available from 3M Company based in St. Paul as Diamond Grade™ High Intensity Prismatic Sheeting, Series 3930. Another example of non-metalized, retroreflective sheeting 60 is described in commonly-assigned U.S. Pat. No. 4,588,258 to Hoopman issued May 13, 1986. Because the cube-corner retroreflective sheeting utilizes a nonmetalized material, it may be used for retroreflective sheeting 60 of raised pavement marker 50a, 50b as it may be placed in front of an RFID tag 16 without inhibiting the transmission of its radio signals.

FIG. 5 illustrates another exemplary raised pavement marker 50b including an RFID tag 16. The raised pavement marker 50b includes a top surface 56 and a bottom surface 58 opposite the top surface 56. The raised pavement marker also includes two opposing angled side surfaces 52, 54 adjacent the top surface 56 and bottom surface 58. In this embodiment, the RFID tag 16 is mounted on the top surface 56. Alternatively, the RFID tag 16 may be within the body of the raised pavement maker 50b, so long as the RFID tag 16 is still readable by the RFID reader 22.

The raised pavement markers 50a, 50b may be made of plastic or other suitable materials. Preferably, if the RFID tags 16 are embedded within the raised pavement marker, then the markers are not made of any metal to interfere with the readability of the RFID tag. The raised pavement markers 50a, 50b may be attached to a road by an adhesive or double sided tape, as is well known by those skilled in the art.

FIG. 6 is a top view of another exemplary embodiment of the vehicle detection and image capture system 70 of the present invention. This embodiment of the system operates very similar to the system 10 describe above, except that the system 70 is used to calculate the speed of a moving vehicle 14 and to capture an image of the vehicle 14 for enforcement purposes. The system includes RFID tags 16, as described in detail above. The RFID tags may be embedded in pavement marking tape 30, as described in detail above in reference to FIG. 3. The pavement marking tape 30 may be in discrete portions or in a longitudinal strip running parallel to the direction of the travel of the vehicles 14. Gantry polls 20 are mounted adjacent the road 12 and include RFID readers 22 and cameras 18, as described above. The vehicle 14 may optionally include an RFID tag 24 located within the vehicle 14, as described above.

The system 70 includes a computer or some other processor (not shown) for the information from the RFID readers 22, cameras 18, and for calculating and recording the speed of the vehicle. At a first moment in time, the vehicle 14 passes over a first RFID tag 16a, blocks the communication (i.e., the signal) between a first RFID reader 22a and a first RFID tag 16a, and the first RFID reader 22a fails to receive a response from the first RFID tag 16a during interrogation. This first moment in time is recorded. Subsequently, the vehicle 14 passes over a second RFID tag 16b, blocks the communication between the second RFID reader 22b and a second RFID tag 16b and the second RFID reader 22b fails to receive a response from the second RFID tag 16b during interrogation. This second moment in time is also recorded. Using this information, a computer calculates the speed of the car based on the known distance between the first RFID tag 16a and the second RFID tag 16b and the difference in time between the first moment and the second moment. The cameras 18a and 18b may capture an image of the vehicle 14 when the vehicle is positioned over the RFID tags 16a, 16b respectively. The image of the vehicle 70 may then be recorded for future enforcement purposes.

Alternatively, the system 70 could include a single RFID reader 22 having a first antenna positioned to interrogate the first RFID tag 16a and a second antenna positioned to interrogate the second RFID tag 16b.

In yet another alternative, the RFID reader 22 of the system 70 may also interrogate the third RFID tag 24 located in the vehicle to record the identification of the vehicle 14.

The system 70 may include any number of RFID tags 16 fixed at locations relative to the road 12 and any number of RFID readers 22 located to interrogate such RFID tags 16. The system may include any number of cameras 18 to capture images of the vehicle 14 as they are traveling over the RFID tags 16 and blocking the signal between the RFID reader 22 and its respective RFID tag 16.

Although individual sections of pavement marking tape 30 are illustrated in FIG. 6, the system 70 may alternatively include raised pavement markers 50a, 50b illustrated and described relative to FIGS. 4 and 5.

The systems 10, 70 are equipped with a variety of electronics (not shown) for communication between the RFID readers 22, cameras 18, and with a central or remote office information system that processes and manages the information received from the different components of the systems 10, 70.

RFID tags 16 typically include an integrated circuit and an RFID antenna. The integrated circuit provides the primary identification function. It includes software and circuitry to permanently store the tag identification and other desirable information, interpret and process commands received from the RFID reader 22, and respond to requests for information by the RFID reader 22. Optionally, the integrated circuit may provide for updating the information stored in its memory (read/write) as opposed to just reading the information out (read only).

The antenna geometry and properties depend on the desired operating frequency of the RFID tag 16. Ultra high frequency is preferred for the system 10, 70. 915 MHz or 2.45 GHz radio frequency-responsive tags would typically include a dipole antenna, such as a linear dipole antenna or a folded dipole antenna. However, other antenna designs are known to those skilled in the art. For passive RFID tags, the antenna intercepts the radio frequency energy radiated by the RFID reader 22 or interrogation source. This signal energy carries both power and commands to the tag. The antenna enables the RFID tag to absorb energy sufficient to power the integrated circuit and thereby provide the response to be detected. Active RFID tags include their own power source, such as a battery. The characteristics of the antenna must be matched to RFID reader 22 in the systems 10, 70 in which they are incorporated. These characteristics are often referred to as antenna characteristic information. Antenna characteristic information may include the type of antenna, polarization of the antenna, for example whether the antenna has a linear or circular polarization.

In one embodiment of the systems 10, 70, the RFID reader 22 may include a steerable RFID antenna. In one embodiment, the steerable RFID antenna includes a mechanically driven servo high gain antenna. In another embodiment, the steerable RFID reader includes electronically steered arrays with phase shifters. In yet another embodiment, the steerable RFID reader includes a plurality of fixed beams that may be simultaneously excited. In another embodiment, the steerable RFID reader includes a plurality of antennas pointing in different directions, and includes a controller for selecting one of said plurality of antennas to read a radio frequency-responsive element. One suitable commercially available RFID reader is the Sirit™ Model Infinity 510 commercially available from 3M Company based in St. Paul Minn. One suitable steerable RFID antenna is the Scala™ Model TY-900 commercially available from Kathrein Inc. based in Medford, Oreg.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A vehicle detection and image capture system, comprising:
a first radio frequency identification tag fixed at a location relative to a road;
a first radio frequency identification reader positioned to interrogate the first radio frequency identification tag; and
a first camera;
wherein a vehicle is detected at the location of the first radio frequency identification tag when the first radio frequency identification reader fails to receive a response from the first radio frequency identification tag during interrogation, and the camera captures an image of the vehicle.

2. The vehicle detection and image capture system of claim 1, further comprising a second radio frequency identification tag located in the vehicle.

3. The vehicle detection and image capture system of claim 2, wherein the first radio frequency identification reader interrogates the second radio frequency identification tag.

4. The vehicle detection and image capture system of claim 3, further comprising a second radio frequency identification reader positioned to interrogate the second radio frequency identification tag.

5. The vehicle detection and image capture system of claim 1, further comprising a plurality of radio frequency identification tags fixed at locations relative to a road, wherein the camera is moveable in the direction of the radio frequency identification tag that failed to respond during the interrogation.

6. The vehicle detection and image capture system of claim 1, further comprising a plurality of radio frequency identification tags fixed at locations relative to the road and a plurality of cameras directed at different radio frequency identification tags.

7. The vehicle detection and image capture system of claim 1, further including a raised pavement marker body including the first radio frequency identification tag.

8. The vehicle detection and image capture system of claim 7, wherein the pavement marker body further comprises retroreflective sheeting.

9. The vehicle detection system of claim 1, further comprising a gantry positioned over the road, wherein the first radio frequency identification reader and camera are attached to the gantry.

10. The vehicle detection system of claim 1, wherein the first radio frequency identification reader continuously interrogates the first radio frequency identification tag.

11. The vehicle detection system of claim 1, further comprising a vehicle, wherein the vehicle is positioned between the radio frequency identification tag and the radio frequency identification reader, and wherein the vehicle blocks the communication between the radio frequency identification tag and the radio frequency identification reader.

12. The vehicle detection system of claim 1, further comprising a longitudinally extending tape, wherein a plurality of radio frequency identification tags are positioned along the tape and the tape is adhered to the road.

13. The vehicle detection and image capture system of claim 12, wherein the longitudinally extending tape is positioned perpendicular to the direction of travel of vehicles.

14. A vehicle detection system and image capture system comprising:
a first and a second radio frequency identification tag fixed at different locations relative to a road; and
a first radio frequency identification reader positioned to interrogate the first radio frequency identification tag;
a camera;
wherein a vehicle is detected at the location of the first radio frequency identification tag when the first radio frequency identification reader fails to receive a response from the first radio frequency identification tag during interrogation, wherein the vehicle is detected at the location of the second radio frequency identification tag when the first radio frequency identification reader fails to receive a response from the second radio frequency identification tag during interrogation, and wherein the speed of the vehicle is calculated for travel between the first and second radio frequency identification tags; and
wherein the camera captures an image of the vehicle.

15. The vehicle detection and image capture system of claim 14, wherein the first radio frequency identification reader includes a first antenna positioned to interrogate the first radio frequency identification tag and a second antenna positioned to interrogate the second radio frequency identification tag.

16. The vehicle detection and image capture system of claim 14, further comprising a second radio frequency identification reader positioned to interrogate the second radio frequency identification tag, wherein the vehicle is detected at the location of the second radio frequency identification tag when the second radio frequency identification reader fails to receive a response from the second radio frequency identification tag during interrogation

17. The vehicle detection and image capture system of claim 14, further comprising a third radio frequency identification tag located in the vehicle.

18. The vehicle detection and image capture system of claim 14, further including a raised pavement marker body including the first radio frequency identification tag.

19. The vehicle detection and image capture system of claim 18, wherein the pavement marker body further comprises retroreflective sheeting.

20. The vehicle detection system of claim 14, further comprising a gantry positioned over the road, wherein the first radio frequency identification reader and camera are attached to the gantry.

21. The vehicle detection system of claim 14, further comprising a plurality of radio frequency identification tags fixed at locations relative to a road.

22. The vehicle detection system of claim 21, further comprising a longitudinally extending tape, wherein the plurality of radio frequency identification tags are positioned along the tape and the tape is adhered to the road, and wherein the longitudinally extending tape is positioned parallel to the direction of travel of vehicles.

23. A method of detecting and capturing an image of a vehicle, comprising:
providing a first radio frequency identification tag fixed at a location relative to a road;
providing a first radio frequency identification reader positioned to interrogate the first radio frequency identification tag; and
providing a first camera;
detecting a vehicle at the location of the first radio frequency identification tag when the first radio frequency identification reader fails to receive a response from the first radio frequency identification tag during interrogation; and
capturing an image of the vehicle with the camera.

24. The method of claim 23, further comprising:
providing a second radio frequency identification tag fixed at a location relative to a road;
detecting a vehicle at the location of the second radio frequency identification tag when the first radio frequency identification reader fails to receive a response from the second radio frequency identification tag during interrogation, wherein the first radio frequency identification reader is positioned to interrogate the second radio frequency identification tag; and
calculating and recording the speed of the vehicle when traveling between the first and second radio frequency identification tags.

25. The method of claim 24, wherein the first radio frequency identification reader includes a first antenna positioned to interrogate the first radio frequency identification tag and a second antenna positioned to interrogate the second radio frequency identification tag.

26. The method of claim 23, further comprising:
providing a second radio frequency identification tag fixed at a location relative to a road;
providing a second radio frequency identification reader positioned to interrogate the second radio frequency identification tag;
detecting a vehicle at the location of the second radio frequency identification tag when the second radio frequency identification reader fails to receive a response from the second radio frequency identification tag during interrogation; and
calculating and recording the speed of the vehicle when traveling between the first and second radio frequency identification tags.

27. The method of claim 23, further comprising:
providing a second radio frequency identification tag located in the vehicle;
interrogating the second radio frequency identification tag;
verifying the vehicle's presence at the location of the first radio frequency identification tag by the information obtained from interrogating the second radio frequency identification tag located in the vehicle.

28. The method of claim 23, further comprising:
verifying the vehicle's presence at the location of the first radio frequency identification tag by the information obtained from the image captured by the camera.
